(19) United States
(12) Patent Application Publication
(10) Pub. No.: US 2020/0109028 A1
(43) Pub. Date: Apr. 9, 2020

(54) CONDITION BASED SHIFTING SAMPLING RATE AND AXIS SELECTION FOR SAMPLING-BASED SENSOR

(71) Applicant: Otis Elevator Company, Farmington, CT (US)

(72) Inventors: Derk Oscar Pahlke, Berlin (DE); Tadeusz Pawel Witczak, Farmington, CT (US); Craig Drew Bogli, Avon, CT (US)

(21) Appl. No.: 16/153,451

(22) Filed: Oct. 5, 2018

(51) Int. Cl. B66B 5/00; G01P 15/18; G01P 1/07

(52) U.S. Cl. CPC B66B 5/0018; G01P 1/07; G01P 15/18

(57) ABSTRACT

A method for controlling a sensor of an elevator car in a hoistway. The method includes monitoring a sampling-based sensor and sampling the sampling-based sensor at a first frequency in response to a first condition of the elevator car occurring. The method also includes sampling the sampling-based sensor at a second frequency in response to a second condition of the elevator car occurring.

### BACKGROUND

Embodiments generally to elevator systems, and more particularly, to switching sampling frequencies based on changing conditions of an elevator system.

Monitoring of the elevator car in the hoistway of an elevator system is important. The monitoring should be conducted over the life of the elevator system. However, sensors fail over time when not properly inspected or maintained. Battery-operated sensors consume power and are sometimes difficult to access which dictates how the sensors are operated and how they are maintained. For example, a sensor operating at a high frequency consumes more power than a sensor operating at a low frequency. What is needed is optimization of the sensor in order to extend the life of the sensor in the elevator system.

### SUMMARY

According to a non-limiting embodiment, a method for controlling a sensor of an elevator car in a hoistway is provided. The method includes monitoring a sampling-based sensor and sampling the sampling-based sensor at a first frequency in response to a first condition of the elevator car occurring. The method also includes sampling the sampling-based sensor at a second frequency in response to a second condition of the elevator car occurring.

In addition to one or more of the features described herein, or as an alternative, further embodiments of the method may include wherein, the first condition is one of: vertical movement of the elevator car in the hoistway; and horizontal movement of a door of the elevator car.

In addition to one or more of the features described herein, or as an alternative, further embodiments of the method may include wherein the second condition is the other of: vertical movement of the elevator car in the hoistway; and horizontal movement of the door of the elevator car.

In addition to one or more of the features described herein, or as an alternative, further embodiments of the method may include reducing energy consumed by the sampling-based sensor.

In addition to one or more of the features described herein, or as an alternative, further embodiments of the method may include movement along a first axis and the second condition comprises movement along a second axis.

In addition to one or more of the features described herein, or as an alternative, further embodiments of the method may include wherein the movement along the first axis is vertical movement along a y-axis of the elevator car in the hoistway and the movement along the second axis is horizontal movement along a x-axis of a door to the elevator car.

In addition to one or more of the features described herein, or as an alternative, further embodiments of the method may include switching from sampling at a low frequency to a high frequency in response to detecting an anomaly associated with movement of the elevator car.

In addition to one or more of the features described herein, or as an alternative, further embodiments of the method may include performing analytics on the elevator car in the hoistway in response to switching from sampling at a low frequency to a high frequency.

In addition to one or more of the features described herein, or as an alternative, further embodiments of the method may include switching between sampling at the first frequency to sampling at the second frequency upon the occurrence of the second condition, wherein the second condition corresponds with at least one of the following: the elevator car moving vertically within the hoistway; the elevator car stopping at a particular landing within the hoistway; and a door of the elevator car moving horizontally.

In addition to one or more of the features described herein, or as an alternative, further embodiments of the method may include wherein the sampling-based sensor is a wireless sampling-based sensor and is battery powered.

In addition to one or more of the features described herein, or as an alternative, further embodiments of the method may include the sampling-based sensor wirelessly transmitting samplings at the first and second frequencies to a computing device.

According to another embodiment, a system for optimizing energy consumption, includes a sampling-based sensor coupled to an elevator car in a hoistway, the sampling-based sensor switching sampling frequency based on conditions of the elevator car, wherein upon occurrence of a first condition the sampling-based sensor outputs at a first frequency and upon occurrence of a second condition the sampling-based sensor switches from the first frequency to a second frequency.

In addition to one or more of the features described herein, or as an alternative, further embodiments of the system may include wherein the sampling-based sensor is an accelerometer and wherein the first condition corresponds with vertical movement of the elevator car in the hoistway and the second condition corresponds with horizontal movement of a door of the elevator car.

In addition to one or more of the features described herein, or as an alternative, further embodiments of the method may include a computing device in communication with the sampling-based sensor, wherein the computing device receives data at the first frequency indicating vertical movement of the elevator car and data at the second frequency indicating horizontal movement of a door to the elevator car.

In addition to one or more of the features described herein, or as an alternative, further embodiments of the method may include wherein the computing device performs analytics on the elevator car in the hoistway in response to receiving frequency samplings at the first and second frequencies.

In addition to one or more of the features described herein, or as an alternative, further embodiments of the method may include in response to the sampling-based sensor detecting an anomaly corresponding with movement of the elevator car, switching from low frequency sampling to high frequency sampling.

According to another embodiment, a computer program product including a computer readable storage medium having program instructions embodied therewith, the program instructions executable by a computer processor to cause the computer processor to perform a method for conserving energy for a sampling-based sensor coupled to an elevator car in a hoistway, comprising: monitoring a sampling-based sensor; sampling the sampling-based sensor at a first frequency in response to a first condition of the elevator car occurring; and sampling the sampling-based sensor at a second frequency in response to a second condition of the elevator car occurring.

In addition to one or more of the features described herein, or as an alternative, further embodiments of the computer program product may include wherein the first condition corresponds with vertical movement of the elevator car in the hoistway and the second condition corresponds with horizontal movement of a door of the elevator car.

In addition to one or more of the features described herein, or as an alternative, further embodiments of the computer program product may include wherein the method further comprises switching from sampling at a low frequency to sampling at a high frequency in response to detecting an anomaly associated with movement of the elevator car and performing analytics on the elevator car in the hoistway in response to sampling at the high frequency.

Additional features and advantages are realized through the techniques of the disclosure. For a better understanding of the disclosure with the advantages and the features, refer to the description and to the drawings.

### BRIEF DESCRIPTION OF THE DRAWINGS

The foregoing and other features, and advantages of the disclosure are apparent from the following detailed description taken in conjunction with the accompanying drawings, in which:

FIG. 1 illustrates a schematic drawing of an elevator system that may be utilized to implement exemplary embodiments of the present disclosure;

FIG. 2 illustrates a perspective view of the movements of an elevator car in a hoistway according to one or more embodiments of the present disclosure;

FIG. 3 depicts a block diagram illustrating an exemplary computer processing system that may be utilized to implement exemplary embodiments of the present disclosure;

FIG. 4A illustrates an example of elevator car motion while monitoring the y-axis at a low sampling rate;

FIG. 4B illustrates an example of door motion of the elevator car while monitoring the x-axis at a low sampling rate;

FIG. 4C illustrates a Fast Fourier Transform (FFT) of a high resolution signal that may be used for advanced analytics of the elevator system; and

FIG. 5 is a flow diagram illustrating a method for detecting movement of an elevator car in a hoistway according to one or more embodiments of the present disclosure.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the disclosure are described herein with reference to the related drawings. Alternative embodiments of the disclosure can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the disclosure may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

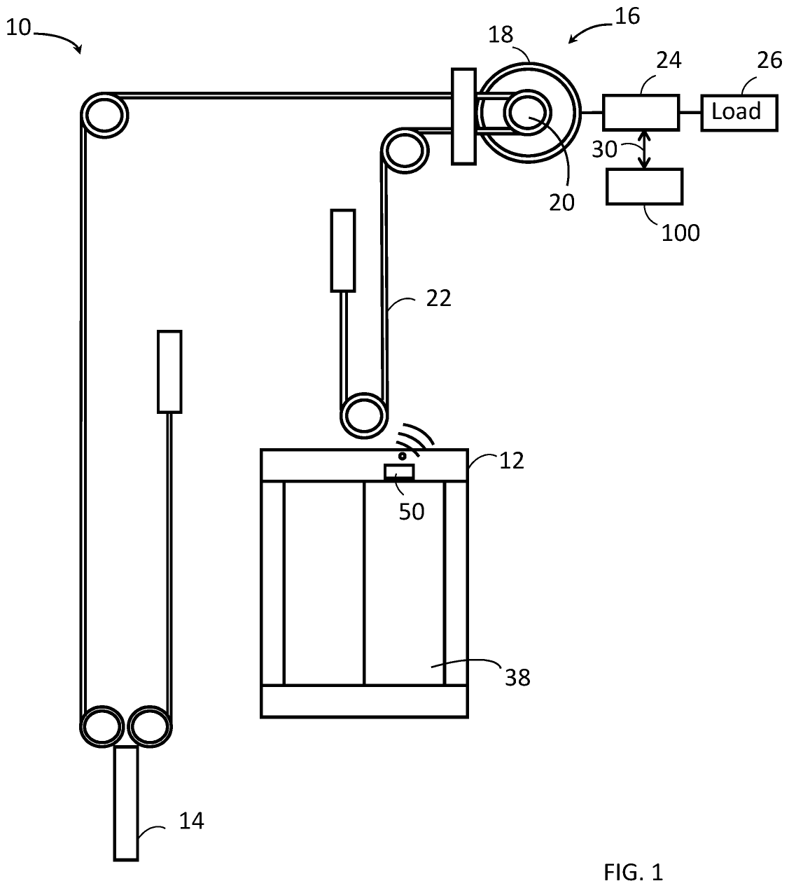

FIG. 1 illustrates selected portions of an elevator system generally indicated at 10. The elevator system 10 includes an elevator car 12 and counterweight 14. A roping arrangement 22 (e.g., round ropes or flat belts) supports the weight of the elevator car 12 and counterweight 14 in a known manner.

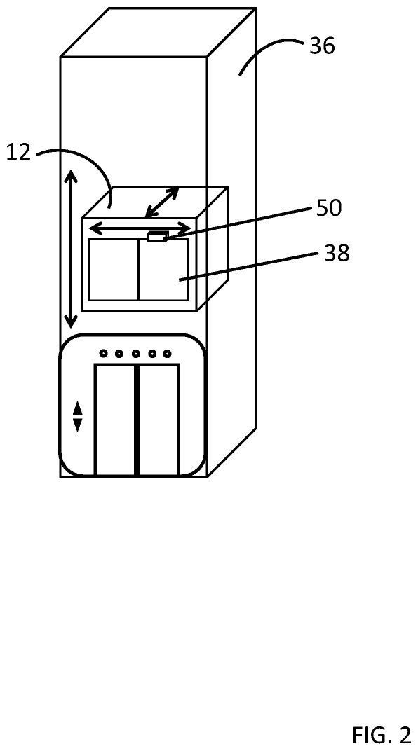

An elevator machine 16 includes a motor 18 associated with a traction sheave 20. The motor 18 selectively causes movement of the traction sheave 20 to cause corresponding movement of the roping arrangement 22 to control the position and movement of the elevator car 12 within a hoistway 36 (FIG. 2). When a motive force is required from the motor 18 for moving the traction sheave 20, the elevator machine 16 operates in a first mode in which it consumes electrical power. Under some operating conditions, the elevator car 12 can move without requiring a motive force from the motor 18.

Under some conditions, for example, the weight of the counterweight 14 can be relied upon to cause the elevator car 12 to rise within the hoistway as the counterweight 14 is allowed to descend. Releasing the brake of the elevator machine 16 and allowing the components of the motor 18 to rotate with the rotation of the traction sheave 20 under such conditions allows for the motor 18 to generate electrical power.

The example elevator machine 18 includes a drive portion 24 for providing electrical power to the motor 18 operating in the first mode and in some instances providing electrical power generated by the motor 18 to a load 26 when the motor 18 operates in the second mode. In one example, the load 26 comprises a power grid interface.

The drive portion 24 is also in communication with an external computing device 100. It will be appreciated that the external computing device 100 may include a server, an external CPU, laptop, and cloud-based server to name a few non-limiting examples. The external computing device 100 is configured to receive data from the drive portion 24 via communication line 30, determine elevator operational parameters based at least in part on the operational data received from the drive portion 24, and transmit commands to the drive portion 24 based at least in part on the elevator operational parameters via the communication line 30. It will be appreciated that the external computing device 100 may request operational data from the drive portion 24. It will also be appreciated that the drive portion 24 may be in communication with the external computing device 100 via a wired or wireless connection.

Although shown and described with a roping system including roping arrangement 22, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

With reference now to FIG. 1 and FIG. 2, the elevator car 12 includes one or more sampling-based sensors 50 communicating with the computing device 100 or through an elevator controller or any other desired intermediary. The sampling-based sensor 50 is any type of sensor capable of sensing, for example, impact, vibration, motion, acceleration, and inclination, and then transmitting output data at different sampling frequencies or frequency ranges. The frequency levels of the sampling-based sensor 50 preferably can be changed/tuned as needed. For example, the sampling-based sensor 50 may be an accelerometer, a microphone, a pressure sensor, an optical sensor, or an infrared sensor for detecting position or motion. Preferably, the sampling-based sensor 50 is battery powered and communicates wirelessly with the computing device 100. In one or more embodiments, the sampling-based sensor 50 is a wireless accelerometer for sensing axis-based movement or vibration. Also, in one or more embodiments, the sampling-based sensor 50 can be triggered based on readings from more than one location on the elevator car 12. The sampling-based sensor 50 may be a 2-axis or 3-axis wireless accelerometer.

The sampling-based sensor 50 may be coupled to a door 38 of the elevator car 12, to a door header of the elevator car 12, or in another location, capable of detecting movement of the door 38 in the horizontal direction or along the x-axis. The profile of the movement of the door 38 may be based on thresholds of acceleration, velocity, and position. The sampling-based sensor 50 may be attached with magnets or with mechanical fasteners in such a way that the sampling-based sensor 50 may be easily serviced. For example, a battery of the sampling-based sensor 50 may need periodic replacement. The power consumed by the sampling-based sensor 50 should be optimized in order to preserve the life of the battery. The higher the frequency of the data sampled and output, the more power that is consumed by the sampling-based sensor 50.

The same sampling-based sensor 50, or another separate sampling-based sensor 50, can also detect movement of the elevator car 12 itself in the hoistway 36. Elevator car movement in the hoistway 36 may be based on thresholds of acceleration, velocity, and position. In one or more embodiments, the movement of the elevator car 12 is in the vertical direction or along the y-axis in the hoistway 36. Moreover, as show in FIG. 2, movement or vibration of the elevator car 12 along a third-axis may also be detected relative the hoistway 36.

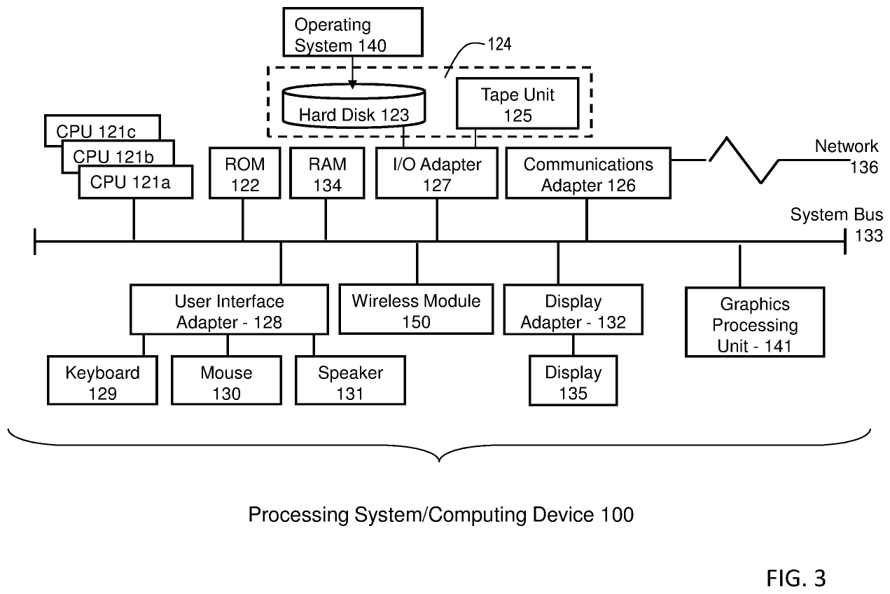

Referring to FIG. 3, there is shown an embodiment of a processing system, commonly referred to as a computer processing system or the computing device 100, for implementing the teachings herein. The computing device 100 may be implemented as part of the sampling-based sensor 50 or as a stand-alone device. The computing device 100 has one or more central processing units (processors) 121a, 121b, 121c, etc. (collectively or generically referred to as processor(s) 121). In one or more embodiments, each processor 121 may include a reduced instruction set computer (RISC) microprocessor. Processors 121 are coupled to system memory (RAM) 134 and various other components via a system bus 133. Read only memory (ROM) 122 is coupled to the system bus 133 and may include a basic input/output system (BIOS), which controls certain basic functions of computing device 100.

FIG. 3 further depicts an input/output (I/O) adapter 127 and a network adapter 126 coupled to the system bus 133. I/O adapter 127 may be a small computer system interface (SCSI) adapter that communicates with a hard disk 123 and/or tape storage drive 125 or any other similar component. I/O adapter 127, hard disk 123, and tape storage device 125 are collectively referred to herein as mass storage 124.

Operating system 140 for execution on the processing system 100 may be stored in mass storage 124. However, the operating system 140 may also be stored in RAM 134 of the computing device 100. Operating systems useful in planning a route for a convoy of automobiles according to embodiments of the present disclosure include, for example, UNIX™, Linux™, Microsoft XP™, AIX™, and IBM's i5/OS™.

A network adapter 126 interconnects bus 133 with an outside network 136 enabling the computing device 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 127, 126, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 133 via user interface adapter 128 and display adapter 132. A keyboard 129, mouse 130, and speaker 131 all interconnected to bus 133 via user interface adapter 128, which may include, for example, a Super I/O chip integrating multiple device adapters into a single integrated circuit.

In exemplary embodiments, the computing device 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 3, the computing device 100 includes processing capability in the form of processors 121, storage capability including RAM 134 and mass storage 124, input means such as keyboard 129 and mouse 130, and output capability including speaker 131 and display 135. In one embodiment, a portion of RAM 134 and mass storage 124 collectively store the operating system to coordinate the functions of the various components shown in FIG. 3. The computing device 100 also includes a wireless module 150 for communicating with the sampling-based sensor 50.

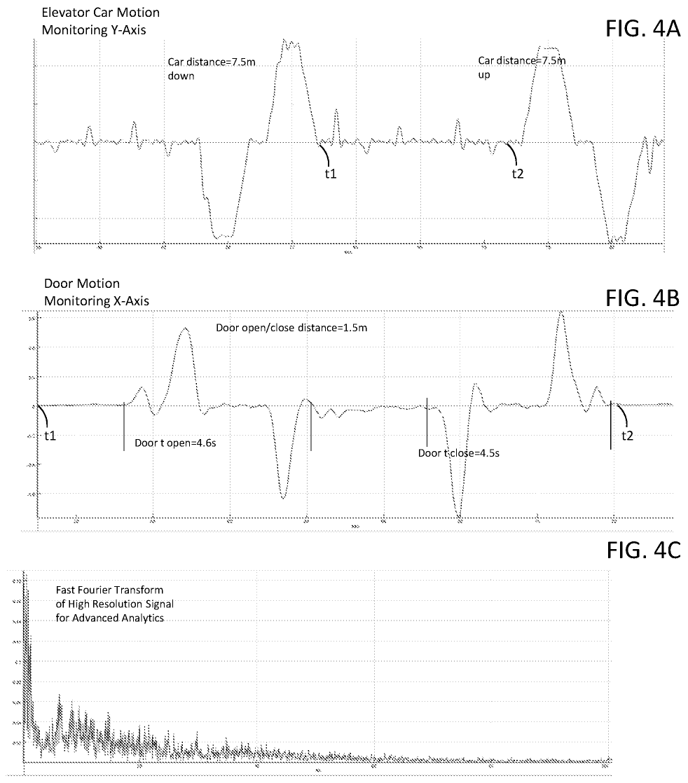

FIG. 4A illustrates motion of the elevator car 12 while monitoring the y-axis at a low sampling frequency. As shown in FIG. 4A, the elevator car 12 first moves down and then moves up. FIG. 4B is a subset in time of FIG. 4A and illustrates the opening and closing motion of the door 38 while monitoring the x-axis at a low sampling frequency. In accordance with one or more embodiments, analytics can be performed on the data obtained at a low sampling frequency but in such case the analytics will be less precise compared to analytics performed based on data obtained at higher sampling frequencies. For example, when the motion of the door 38 is detected, such as when the elevator car 12 is stationary or at a low speed, a higher sampling frequency can be used in order to collect more precise data. Triggers other than the motion of the door 38 may also be used in order to switch to a higher sampling frequency. Thus, sampling either the elevator car 12 motion or the motion of the door 38 at a higher sampling frequency yields higher resolution data for more advanced analytics. For example, at a higher sampling frequency such as, for example 200 Hz, the obtained higher resolution data can be used to generate predictive health scores for the elevator system 10 based on a Fast Fourier Transform (FFT) as shown in FIG. 4C.

In one or more embodiments, the sampling-based sensor 50 is sampled at a first frequency in response to a first condition such as movement along the y-axis of the elevator car 12 in the hoistway 36. The sampling-based sensor 50 is sampled at a second frequency in response to a second condition such as movement detected along the x-axis of the door 38. For example, the sampling-based sensor 50 outputs data at a first low sampling frequency such as, for example, in the range of about 2 Hz to about 20 Hz, upon vertical elevator car 12 movement. Also, for example, the sampling-based sensor 50 outputs data at a different second low to medium sampling frequency such as, for example, in the range of about 50 Hz, upon horizontal movement of the door 38 of the elevator car 12. Thus, the sampling-based sensor 50 switches between different sampling frequencies based on conditions occurring in regard to the movement of the elevator car 12 itself and in regard to the movement of the door 38 to the elevator car 12. In one or more embodiments, the sampling frequency can be switched from a low sampling frequency such as, for example, about 0 to 2 Hz in response to the elevator car 12 and door 38 being stationary to a higher sampling frequency such as, for example, about 20 Hz in response to the elevator car 12 or the door 38 moving. Also, the number of times the frequency changes can be limited based on elevator car 12 motion or door 38 motion per landing or per run during a day or during another time period.

Although the first condition and the second condition described above correspond with vertical movement of the elevator car 12 and horizontal movement of the door 38 to the elevator car 12, the conditions may instead correspond with the occurrence of other movements or actions of the elevator system 10 such as the elevator car 12. In one or more embodiments, the sampling frequency is higher in response to movement in one direction than the sampling frequency in response to movement in another direction. Also, in one or more other embodiments, the sampling may be more rapid along the y-axis when the elevator car 12 is moving up and down and more rapid along the x-axis when the door 38 to the elevator car is opening and closing. Switching to a higher sampling frequency may also occur in response to the elevator car beginning to move and while moving within the hoistway 36 or in response to the elevator car 12 being stopped and the door 38 moving.

In one or more embodiments, the sampling-based sensor 50 may output data for sampling in response to an anomaly associated with movement of the elevator car 12. For example, sampling at a higher frequency may occur in response to detecting the anomaly. The sampling frequency may be switched automatically to a higher sampling frequency such as, for example, about 200 Hz in order to get output data. Analytics may be performed on the elevator car 12 in the hoistway 36 in response to sampling at a higher particular frequency.

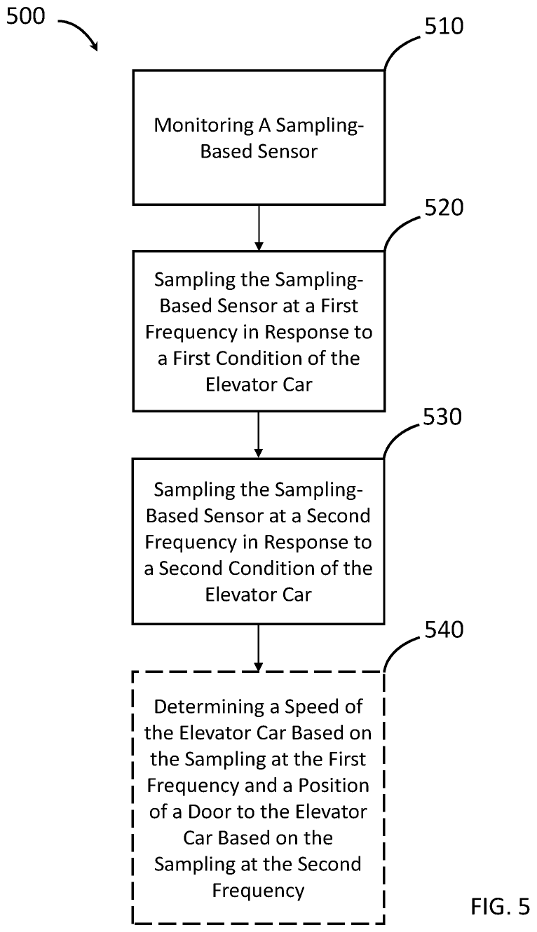

Turning to FIG. 5, one or more embodiments may include a method 500 for detecting movement of the elevator car 12 in the hoistway 36. The flow diagram of FIG. 5 illustrates the method 500 that includes process block 510 for the computing device 100 monitoring the sampling-based sensor 50. The method 500 also includes process block 520 for sampling the sampling-based sensor 50 at a first frequency in response to a first condition of the elevator car 12 occurring and process block 530 for sampling the sampling-based sensor 50 at a second frequency in response to a second condition of the elevator car 12 occurring. For example, in one embodiment, the sampling-based sensor 50 is sampled at about 20 Hz in response to the elevator car 12 moving upward or downward within the hoistway 36. Then, in response to the door 38 of the elevator car 12 opening and closing at a landing of the hoistway 36, the sampling-based sensor 50 is sampled at a higher frequency of, for example, about 200 Hz. In another example, the sampling-based sensor 50 is sampled at about 2 Hz in response to the elevator car 12 and door 38 being stationary within the hoistway 36 and then, in response to the elevator car 12 moving up or down or the door 38 of the elevator car 12 opening or closing, the sampling-based sensor 50 is sampled at about 20 Hz. Also, the sampling-based sensor 50 may be sampled at 200 Hz in response to detecting an anomaly associated with the elevator car 12 moving up or down or the door 38 opening or closing. In yet another example, the sampling-based sensor 50 is sampled at, for example, about 20 Hz in response to the power of the battery of the sampling-based sensor 50 of the elevator car 12 being above a threshold such as, for example, 50%, and then in response to the power of the battery of the sampling-based sensor 50 of the elevator car 12 going below the threshold of about 50%, sampling the sampling-based sensor 50 of the elevator car 12 at a lower sampling frequency of, for example, about 20 Hz.

The method 500 may also include process block 540 for determining the speed of the elevator car 12 in the hoistway 36 based on the sampling at the first frequency and a position of the door 38 to the elevator car 12 based on the sampling at the second frequency. The process 500 reduces energy consumed by the sampling-based sensor 50. In one or more embodiments, the sampling-based sensor 50 is an accelerometer wherein the first condition is one of: vertical movement of the elevator car 12 in the hoistway 36 and horizontal movement of the door 38 of the elevator car 12. Thus, the second condition is the other of: vertical movement of the elevator car 12 in the hoistway 36 and horizontal movement of the door 38 of the elevator car 12.

Various technical benefits are achieved using the system and methods described herein, including the capability of providing enhanced performance for applications with exclusive access to the co-processors while also allowing applications that do not need performance access to accelerators when shared access is available. In this manner, the computing device can realize performance gains through the use of co-processors in the system, thereby improving overall processing speeds.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for controlling a sampling-based sensor of an elevator car in a hoistway, the method comprising:
monitoring a sampling-based sensor;
sampling the sampling-based sensor at a first frequency in response to a first condition of the elevator car occurring; and
sampling the sampling-based sensor at a second frequency in response to a second condition of the elevator car occurring.

2. The method of claim 1 wherein the sampling-based sensor is an accelerometer and wherein the first condition is one of:
vertical movement of the elevator car in the hoistway; and
horizontal movement of a door of the elevator car.

3. The method of claim 2 wherein the second condition is the other of:
vertical movement of the elevator car in the hoistway; and
horizontal movement of the door of the elevator car.

4. The method of claim 1 further comprising reducing energy consumed by the sampling-based sensor.

5. The method of claim 1 wherein the first condition comprises movement along a first axis and the second condition comprises movement along a second axis.

6. The method of claim 5 wherein the movement along the first axis is vertical movement along a y-axis of the elevator car in the hoistway and the movement along the second axis is horizontal movement along a x-axis of a door to the elevator car.

7. The method of claim 1 further comprising switching from sampling at a low frequency to a high frequency in response to detecting an anomaly associated with movement of the elevator car.

8. The method of claim 7 further comprising performing analytics on the elevator car in the hoistway in response to switching from sampling at a low frequency to a high frequency.

9. The method of claim 1 further comprising switching between sampling at the first frequency to sampling at the second frequency upon the occurrence of the second condition, wherein the second condition corresponds with at least one of the following:
the elevator car moving vertically within the hoistway;
the elevator car stopping within the hoistway; and
a door of the elevator car moving horizontally.

10. The method of claim 1 wherein the sampling-based sensor is a wireless sampling-based sensor and is battery powered.

11. The method of claim 1 further comprising the sampling-based sensor wirelessly transmitting samplings at the first and second frequencies to a computing device.

12. A system for optimizing energy consumption, the system comprising a sampling-based sensor coupled to an elevator car in a hoistway, the sampling-based sensor switching sampling frequency based on conditions of the elevator car, wherein upon occurrence of a first condition the sampling-based sensor outputs at a first frequency and upon occurrence of a second condition the sampling-based sensor switches from the first frequency to a second frequency.

13. The system of claim 12 wherein the sampling-based sensor is an accelerometer and wherein the first condition corresponds with vertical movement of the elevator car in the hoistway and the second condition corresponds with horizontal movement of a door of the elevator car.

14. The system of claim 12 further comprising a computing device in communication with the sampling-based sensor, wherein the computing device receives data at the first frequency indicating vertical movement of the elevator car and data at the second frequency indicating horizontal movement of a door to the elevator car.

15. The system of claim 14 wherein the computing device performs analytics on the elevator car in the hoistway in response to receiving frequency samplings at the first and second frequencies.

16. The system of claim 14 further comprising, in response to the sampling-based sensor detecting an anomaly corresponding with movement of the elevator car, switching from low frequency sampling to high frequency sampling.

17. A computer program product comprising a computer readable storage medium having program instructions embodied therewith, the program instructions executable by a computer processor to cause the computer processor to perform a method for conserving energy for a sampling-based sensor coupled to an elevator car in a hoistway, comprising:
monitoring a sampling-based sensor;
sampling the sampling-based sensor at a first frequency in response to a first condition of the elevator car occurring; and
sampling the sampling-based sensor at a second frequency in response to a second condition of the elevator car occurring.

18. The computer program product of claim 17 wherein the first condition corresponds with vertical movement of the elevator car in the hoistway and the second condition corresponds with horizontal movement of a door of the elevator car.

19. The computer program product of claim 17 wherein the method further comprises determining a speed of the elevator car in the hoistway based on the sampling at the first frequency and a position of a door of the elevator car based on the sampling at the second frequency.

20. The computer program product of claim 17 wherein the method further comprises switching from sampling at a low frequency to sampling at a high frequency in response to detecting an anomaly associated with movement of the elevator car and performing analytics on the elevator car in the hoistway in response to sampling at the high frequency.
